(19) United States
(12) Patent Application Publication
(10) Pub. No.: US 2015/0149535 A1
(43) Pub. Date: May 28, 2015

(54) Systems And Methods For Application Execution And Deployment Cloud

(71) Applicant: Massively Parallel Technologies, Inc., Boulder, CO (US)

(72) Inventor: Kevin D. Howard, Tempe, AZ (US)

(21) Appl. No.: 14/555,369

(22) Filed: Nov. 26, 2014

Related U.S. Application Data
(60) Provisional application No. 61/909,768, filed on Nov. 27, 2013.

(51) Int. Cl. H04L 29/08

(52) U.S. Cl. CPC H04L 67/34; H04L 67/16
USPC 709/203

(57) ABSTRACT

A system including a server having a processor coupled to memory storing instructions capable of providing advanced software as a service (AdSaaS) to a user. The AdSaaS allows a user to select an application and a version of the application for execution. The AdSaaS may further allow a user to create a complex workflow including more than one application executing on a given dataset. The AdSaaS may be presented in user workspace accessible by the user on a developer cloud hosted by the server whereby more than one user may access the workspace at a given time. Moreover, licenses owned by a user may be shared with other users through the workspace.

### RELATED APPLICATIONS

This application claims priority to U.S. Provisional Patent Application Ser. No. 61/909,768, filed on Nov. 27, 2013 and which is incorporated by reference herewith in its entirety.

### BACKGROUND

Cloud computing is a model that delivers computing hardware and software services over either a network or a network of networks (e.g., the Internet). There are several service models in current use for cloud computing: software as a service (SaaS), network as a service (NaaS), platform as a service (PaaS), infrastructure as a service (IaaS), and collaboration as a service (CaaS). The existing art only provides for a few of these models at a time, typically not all of the models.

### SUMMARY

In one embodiment, a system allows a user to run an application and has a server including a processor coupled with memory storing instructions executable by the processor. The instructions, when executed by the processor, are capable of providing, within a development cloud hosted by the server and accessible by a user, advanced software as a service (AdSaaS), where the AdSaaS (a) allows the user to select a version of an application stored within the memory, and (b) allows the user to execute a selected version of the application.

### BRIEF DESCRIPTION OF THE FIGURES

FIG. 1A shows one exemplary application execution and deployment cloud computing system that implements service models including: software as a service (SaaS), network as a service (NaaS), platform as a service (PaaS), infrastructure as a service (IaaS), and collaboration as a service (CaaS), in an embodiment.

FIG. 1B shows an illustrative representation of an Inter/IntraCloud Model, which is one possible embodiment of the system of FIG. 1A.

FIG. 2 shows a BCH login screen, in an embodiment.

FIG. 3 shows a BCH sign up screen, in an embodiment.

FIG. 4 shows a Credit/Debit Card request screen and a Checking Account Information request screen, in an embodiment.

FIG. 5 shows a user workspace, in an embodiment.

FIG. 6 shows an application licensing screen, in an embodiment.

FIG. 7 shows found applications with selected to-be compared entries, in an embodiment.

FIG. 8 shows a multiple application input screen for comparison, in an embodiment.

FIG. 9 shows a speed-up chart, in an embodiment.

FIG. 10 shows an application/object that has been dragged and dropped onto a showing uses left, in an embodiment.

FIG. 11 shows a BCH application/object with an input and an output dataset, in an embodiment.

FIG. 12 shows a parallel application/object with an associated speedup chart, in an embodiment.

FIG. 13 shows a simple, linked parallel applications/object without data storage, in an embodiment.

FIG. 14 shows a simple, linked parallel applications/objects formed as simple workflow with data storage, in an embodiment.

FIG. 15 shows a simple, linked parallel applications/objects formed as simple workflow with data storage and control, in an embodiment.

FIG. 16 shows a control condition menu, in an embodiment.

FIG. 17 shows a variable selection menu for selecting data transmitted via a data arrow, in an embodiment.

FIG. 18 shows grouping a workflow, in an embodiment.

FIG. 19 shows a manage friends screen, in an embodiment.

FIG. 20 shows a friend engagement request within a shared workspace, in an embodiment.

FIG. 21 shows a collaboration screen including a video and instant messenger (IM) sessions, in an embodiment.

FIG. 22 shows a shared workspace with license uses added to a workflow object, in an embodiment.

FIG. 23 shows a shared workspace with an authorization by a friend to use their machine for “Regular” object execution, in an embodiment.

### DETAILED DESCRIPTION OF THE FIGURES

This disclosure expands use of Howard Cascades, Howard-Lupo Manifolds, and Howard-Lupo Hypermanifolds, such as described in U.S. Patent Application Publication Number 2008/0082933 to Howard et al., which is incorporated herein by reference.

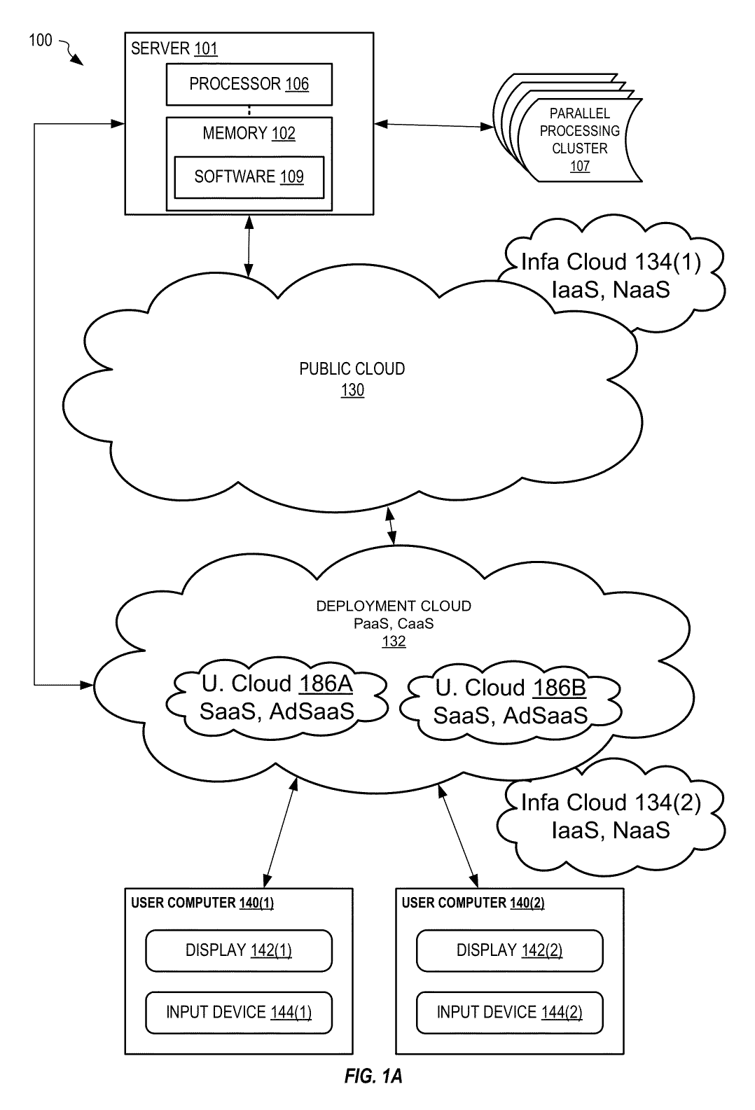

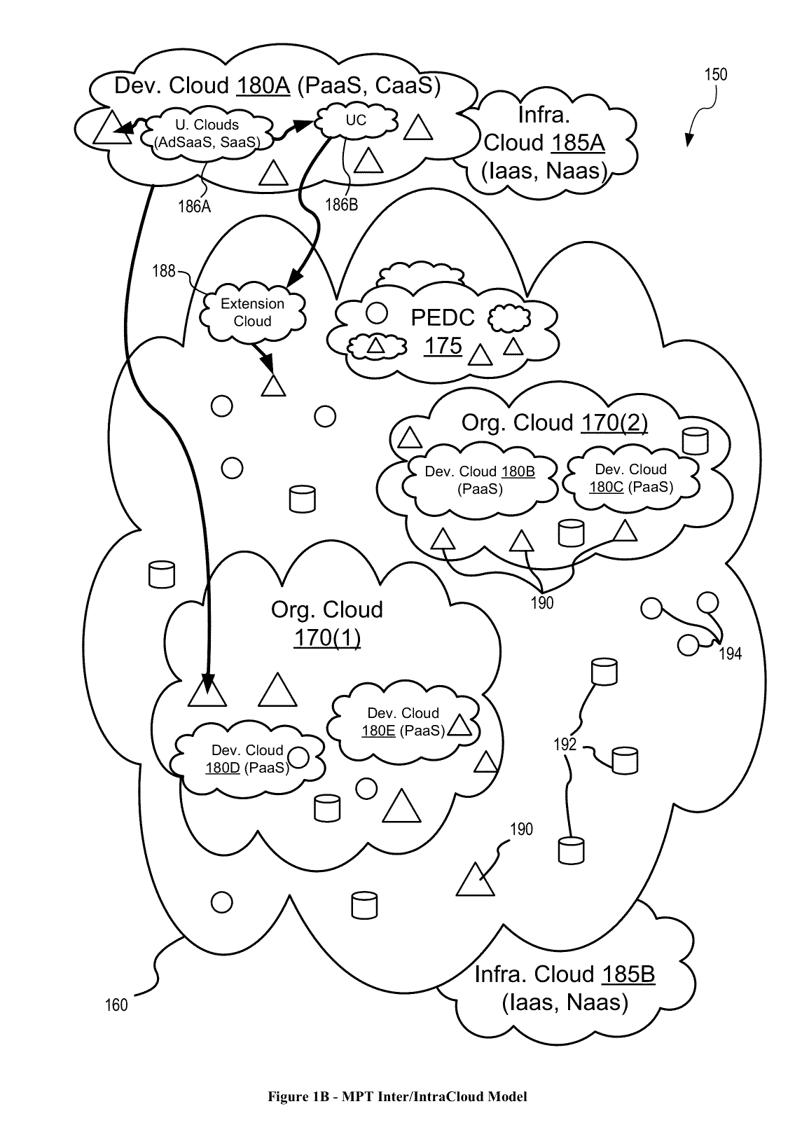

FIG. 1A shows one exemplary application execution and deployment cloud computing system 100 that includes a server 101 and a parallel processing cluster 107 for implementing service models including: software as a service (SaaS), network as a service (NaaS), platform as a service (PaaS), infrastructure as a service (IaaS), and collaboration as a service (CaaS). FIG. 1A shows a public cloud 130 and a development cloud 132. Both cloud 130 and 132 are in communication with infrastructure clouds 134(1) and 134(2), respectively, which provide IaaS and NaaS functionality. The cloud structure shown in FIG. 1A is simplified for sake of clarity, but it should be understood that the cloud structure of system 100 may be complex, allowing for the creation, testing, and distribution of applications. System 100 allows one or more users, utilizing computers such as user computers 140(1), 140 (2), to jointly or individually create complex workflows, purchase applications, and legally share application licenses within the complex cloud structure. This document discusses the distribution cloud sub-structure, the deployment cloud.

In the embodiment of FIG. 1A, two user computers 140(1), 140(2) are in communication with a development cloud 132. The user computers 140(1), 140(2) are shown with displays 142(1), 142(2) and input devices 144(1), 144(2), respectively, for interacting with the system 100. Development cloud 132 may be implemented as a plurality of development clouds 132 without departing from the scope herein. Development cloud 132 provides functionality for PaaS and CaaS. In addition, development cloud includes user clouds 186A, 186B associated with user computer 140(1), 140(2), respectively. More or fewer user clouds 186 may be present without departing from the scope herein. Clouds 186 provide functionality for SaaS and Advansed System as a Service (AdSaaS).

Server 101 includes a processor 106, memory 102, and software 109 within memory 102. Processor 106 or server 101 may execute software 109 to implement functionality to supports all clouds 130, 132, 134, 186 within system 100. In addition, servers 101, is in communication with a parallel processing cluster 107. Parallel processing cluster 107 executes all parallel processing functionality within system 100 and may be configured as, for example, one or more of: Howard Cascade(s), Howard-Lupo Manifold(s), and Howard-Lupo Hypermanifold(s) such as described in U.S. Patent Application Publication Number 2008/0082933 to Howard et al.

Inter/IntraCloud Model

FIG. 1B shows an illustrative representation of an Inter/IntraCloud Model 150, as implemented by system 100, FIG. 1A. An Inter/IntraCloud is a complex aggregation of cloud and cloud-service models wherein each cloud and cloud-service model is hosted by the server 101. Within the Inter/IntraCloud Model, is shown with four primary cloud types; Public Development Clouds, Private External Development Clouds, Development Clouds, and Extension Clouds. In the example of FIG. 1B, Inter/IntraCloud Model 150 is shown with various cloud and cloud services, including a Public Development Cloud 160 (similar to Public Cloud 130, FIG. 1A), a Private External Development Cloud 175, and five Development Clouds 180A-E (similar to Development Cloud 132, FIG. 1A), and Extension Clouds 188. Inter/IntraCloud Model 150 also includes two Organizational Clouds 170(1), 170(2), two User Clouds 186A-B , and two Infrastructure Clouds 185A-B (similar to Infrastructure Clouds 134(1), 134(2), FIG. 1A). In addition, a plurality of Algorithms 190, Databases 192, and Kernel's 194 are also shown. Integration of the various cloud and cloud-service models has advantages over existing, piecemeal models. Other Inter/IntraCloud Models may alter the type and number of cloud and cloud-service models and supporting elements without departing from the scope herein.

Deployment Cloud

Deployment clouds may combine various user cloud services, for example, software as a service (SaaS), network as a service (NaaS), platform as a service (PaaS), infrastructure as a service (IaaS), and collaboration as a service (CaaS). In addition development clouds may build upon traditional SaaS to produce advanced software as a service (AdSaaS). In the example of FIG. 1B, user clouds 185A-B implement SaaS and AdSaaS, Infrastructure Cloud 185A-B implement IaaS and NaaS, and Development Clouds 180A-E implement PaaS and CaaS. The deployment cloud provides functionality to purchased, shared, combined, and run applications, that is, the deployment cloud is an application deployment.

Similar to a typical SaaS, users register with the deployment cloud, to gain access to all available applications and services within, in communication with, and accessible by the development cloud. In one embodiment, the user may, on a trial basis, try out various applications utilizing the user's own dataset. Alternatively, the user may utilize a test dataset, re-executing the application multiple times. If an application fits the user's criteria, the user may license the application. After licensing the application, the licensed application becomes available within the user's cloud storage space such that it may be executed according to the license agreement. Additionally, storage within the user's cloud enables the user to access the licensed application on different devices.

Advanced software as service (AdSaaS) allows the user to select and execute a particular version of an application. Another advantage of AdSaaS is it provides functionality for user selection of the parallel processing speed for a selected application. Also, AdSaaS may utilize parallel methods means of system 100, 150 for allocation, de-allocation, and manipulation of networks (NaaS). In an example of use, the user interacts with the application through Platform as a Service (PaaS) of system 100, 150, one example of which is a web-browser interface platform. User input and results data may be stored in the user's cloud storage space. Additional storage may be optionally acquired, for example by purchasing or borrowing from co-developers (co-users), purchased and utilized through the deployment cloud's IaaS. It should be understood that present system and method is extremely flexible, allowing, for example, multiple users to collaborate by combining application licenses in a shared workspace, which are advanced, multi-application workflows (CaaS).

SaaS and AdSaaS

Software as a service (SaaS) allows a user to access an application in an on-demand fashion using, for example, a web-browser interface. Typically, a user requests the appropriate cloud application, pays for one or more uses of the application then executes the application in the cloud. The performance of the cloud application is traditionally fixed by the application service provider. AdSaaS, on the other hand, provides functionality such that the user may directly select both (1) a version of the application and (2) desired processing performance of the application.

Standard (SaaS) Operations

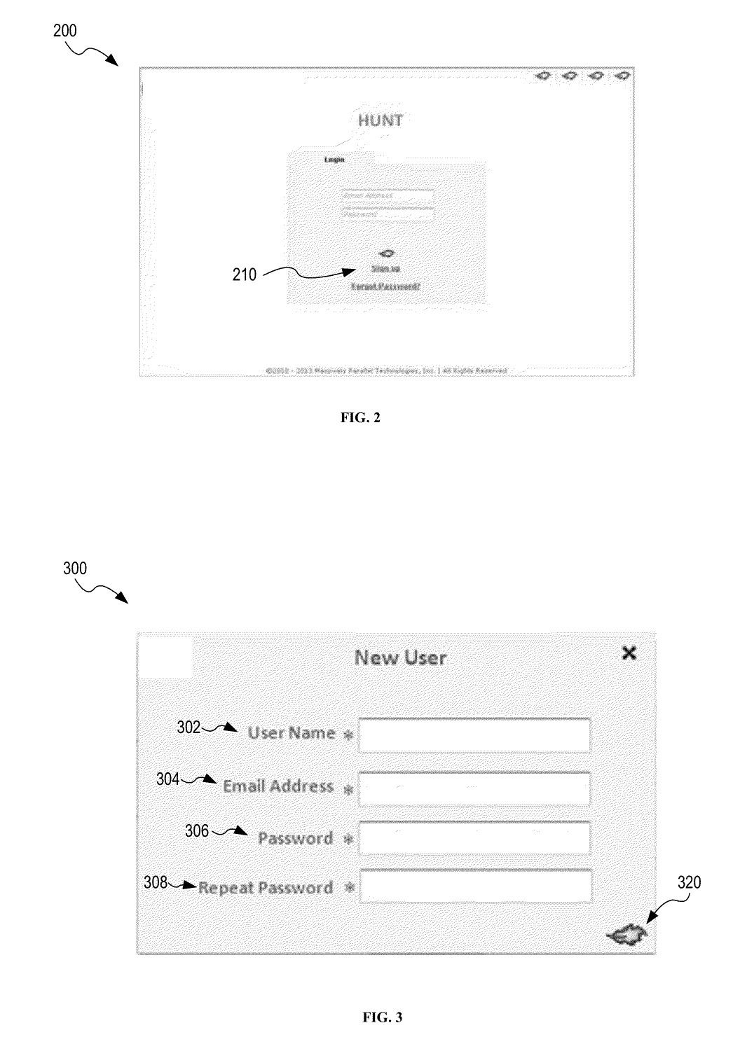

FIGS. 2-23 show exemplary user interfaces for interacting with Inter/IntraCloud Model 150 of cloud computing system 100 of FIG. 1A. User interfaces described in connection with FIGS. 2-23 are generated via software 109 on server 101 and displayed to a user via display 142(1). In the present example, a user accesses system 100, 150, e.g. via an application website to sign up and/or logs into system 100.

FIG. 2 shows system 100's login page 200. By selecting the “Sign Up” button 210, the user causes a “Sign Up” display screen 300 (FIG. 3) to appear.

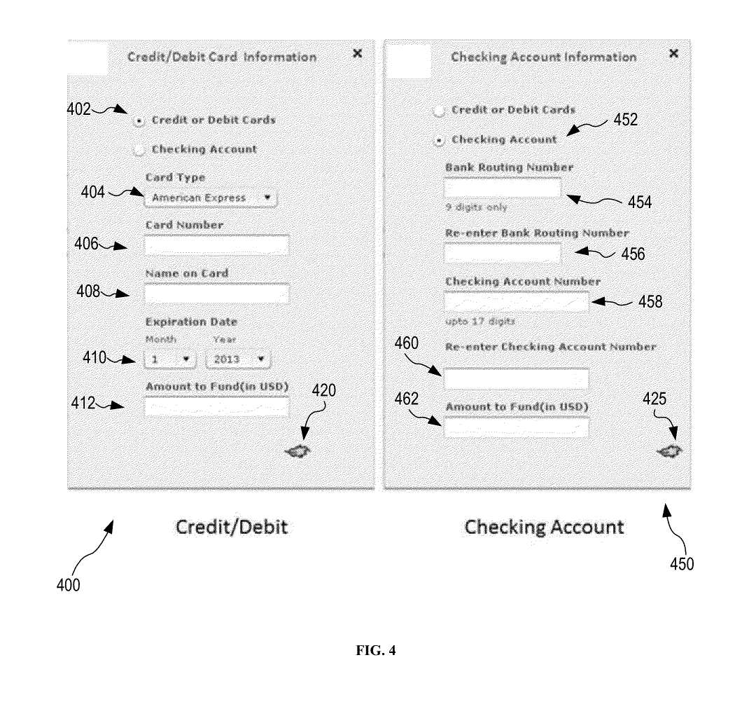

FIG. 3 shows “Sign Up” display screen 300. After all mandatory fields 302-308 are entered and the confirmation button 320 is selected, system 100 displays either a “Credit/Debit Card Information” request screen 400 or a “Checking Account Information” request screen 450 (FIG. 4).

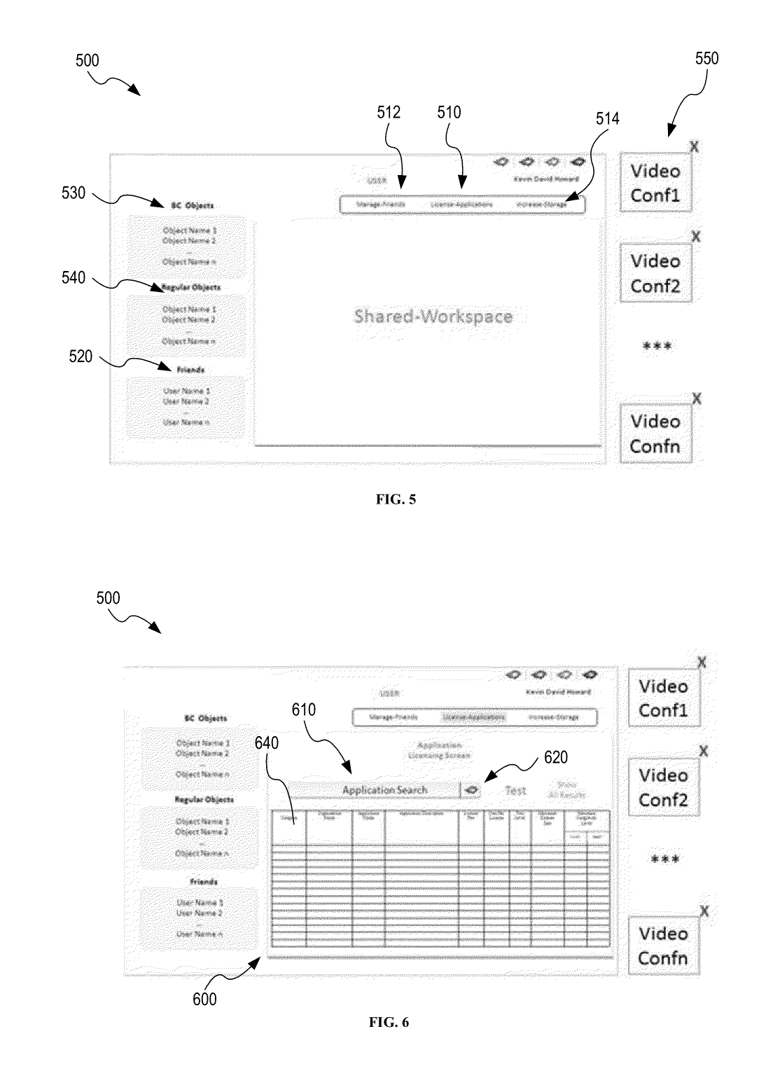

FIG. 4 shows both “Credit/Debit Card Information” request screen 400 and “Checking Account Information” request screen 450. After filling in all requested information, for example requested information 402-412 on both “Credit/Debit Card Information” request screen 400 or requested information 452-462 on “Checking Account Information” request screen 450, and selecting confirmation button 420 or 425, system 100 verifies the credit/debit or checking account information then completes the user sign-up process. Logging in causes a user workspace 500 (FIG. 5) to be displayed. User workspace 500 may be accessed via one or more users (developers) who have access to that given workspace.

FIG. 5 shows user workspace 500. A standard SaaS operation begins with the user selecting a “License Application” button 510, which causes system 100 to display an “Application Licensing” screen 600 (FIG. 6) to be displayed in workspace 500. Also shown on workspace 500 are a manage-friends button 512 and an increase storage button 514.

“Friends”, shown as User Name 1, User Name 2 . . . User Name n, are displayed at “friends” sub-menu 520. Selecting manage-friends button 512 allows the user to control, update or otherwise manipulate data associated with “Friends” that may be displayed in the “friends” sub-menu. Selecting increase storage button 514 activates functionality for interacting with the Development cloud's IaaS, for example, Development Cloud 180's infrastructure cloud 185A to increase the users cloud space storage, (see FIGS. 1A and 1B).

Workspace 500 also shows objects 530, Regular Objects 540, and Video Conference capability 550.

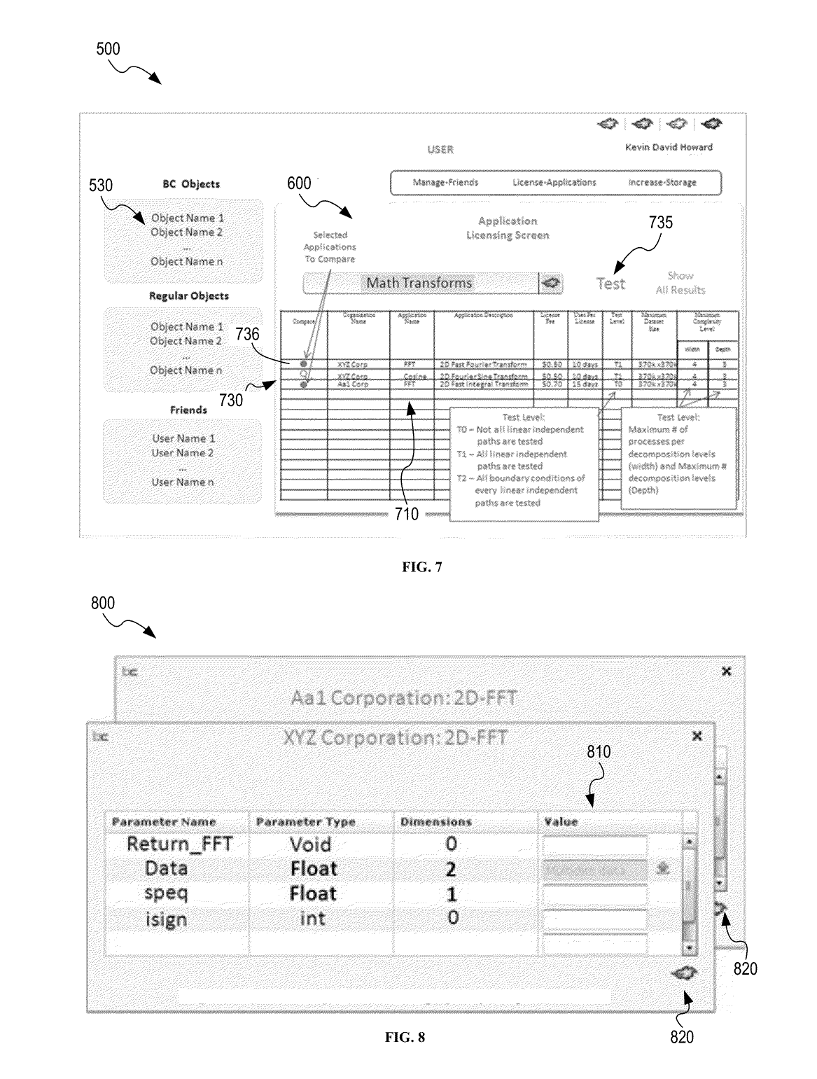

FIG. 6 shows “Application Licensing” screen 600 displayed with workspace 500. Entering a set of space- or comma-separated keywords in an Application Search box 610, then selecting the confirmation button 620, causes a list of applications to be displayed at applications display 640. The list of applications and associated licenses is generated from an application database (not shown) stored within memory 102. See FIG. 7 for more detail on displayed applications for comparison.

FIG. 7 shows multiple applications 710 being displayed within “Application Licensing” screen 600. The multiple applications 710 may be compared against one another by selecting a “Compare” 730 option for each application that is to be compared. Selection of a “Test” button 735 causes input screens 800 (FIG. 8) to be displayed for each selected applications, for example, as a series of tabbed popup screens.

FIG. 8 shows input screens 800, one input screen for XYZ Corporation's two-dimensional fast Fourier transform (2D-FFT) and one input screen for Aa1 Corporation's 2D-FFT, each selected for comparison as shown in FIG. 7. Each of XYZ Corporations and Aa1 Corporation are names for exemplary purposes herein. Also, the 2D-FFT is an exemplary algorithm for decomposing a function into a linear combination of harmonic functions. It should be appreciated that the 2D-FFT is for exemplary purposes only and other algorithms may be compared and executed on system 100 without departing from the scope hereof. Data may be entered into data fields for example, a “value” data field 810. Data field 810 holds the application required input data value. If the application requires dimensional or other data then that data may be entered in a separate row. After data is entered into each application for comparison, the user selects “Submit” buttons 820 of each application. A “Results” screen is then displayed for each application and a comparison chart, including each selected application for comparison, may be displayed. Table 1, below shows one exemplary blank comparison chart.

TABLE 1
Application Comparison

| Organization | Application | License | Uses | Test | Complexity | | | | Speedup |
|---|---|---|---|---|---|---|---|---|---|
| Name | Name | Fee | Per License | Level | Width | Depth | Timing | Precision | Chart |

Note:
Organization Name - Name of the application-generation organization
Application Name - Name and version number of the application
License Fee - Cost to use the application
Uses Per License - # of use-days for which the license is good
Test Level - Indication of how well an application has been tested: T0 - Not all linearly independent pathways have a test procedure. T1 - All linearly independent pathways have at least one test procedure (McCabe's minimum test criteria is met). T2 - Every state transition for every linearly independent path has at least one test procedure (minimum test criteria is met). T3 - Every state transition for every linearly independent path has at least three test procedures: minimum dataset size, medium dataset size, and maximum dataset size. T3R - Every state transition for every linearly independent path has a real-time test for for the minimum, medium, and maximum expected dataset size.
Complexity - Indication of the maximum Cyclomatic Complexity of an application for every code snippet and every decomposition
Timing - Average processing-completion time for the dataset sizes given for the test run
Precision - Number of bits of actual precision associated with the algorithm
Speedup Chart - Graph of the minimum, medium, and maximum speed possible for the algorithm

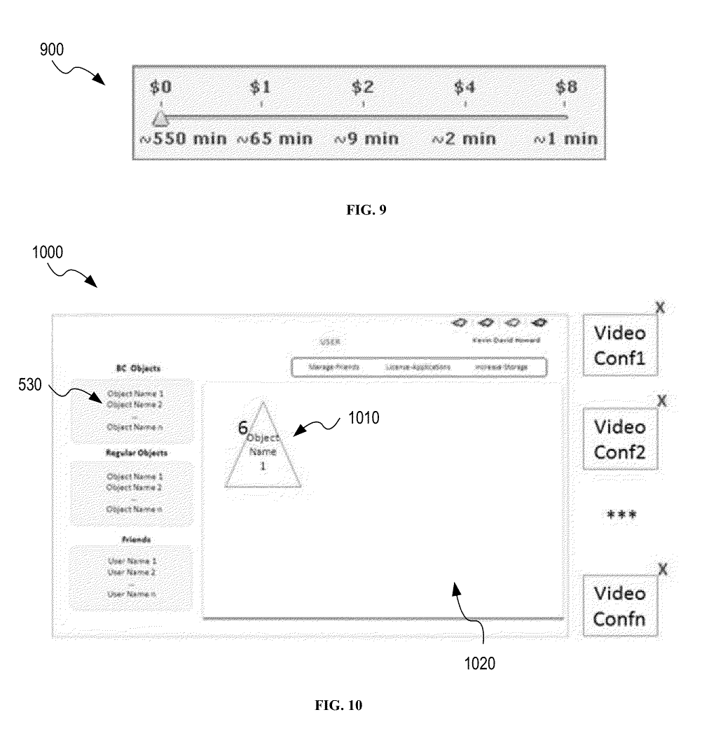

FIG. 9 shows one exemplary Speedup chart 900. Speedup chart 900 is stored within a speedup configuration table (not shown) stored within memory 102.

Speedup Chart 900 shows an interactive aspect of system 100, 150 for controlling functionality for dynamically changing network connections within system 100, 150 such that parallel processing across its network may be manipulated. In other words, the user can set the processing time for a given application (depending on the application and physical configuration of the system) while also selecting the price for executing that application. This functionality represents one example of a Network as a service (NaaS) capability, shown in both FIG. 1A and FIG. 1B. Speedup Chart 900 shows cost versus computational time. In alternative embodiments, the computational time may be replaced by number of nodes used for processing a task, such that the user may control the number of nodes that work in parallel to process a task or given application.

Purchasing a license within system 100, 150 requires that the user's credit card or checking account is pre-registered within the system 100, 150. Selecting an application for licensing, for example by double-clicking a row 736 that identifies the application to be licensed, purchases a license for that application. If the user already has a license for the application, then the selecting the application during this purchasing step increases the number of application uses the user has available. Once licensed, an icon representing the application is placed in the user's “Objects” area 530.

Advanced SaaS

Unlike standard SaaS, advanced SaaS (AdSaaS) allows a user to generate a mixed, complex workflow using combined botnet and dynamically scalable, high-performance computer-software components. For example, the user may select multiple applications for execution of a task; particular versions of each of the multiple applications for execution; and particular processing speeds for given tasks/applications. Other features and advantages of AdSaaS are apparent throughout the disclosure herein.

Simple Workflows

To build a simple workflow, the user drags and drops an Object onto the shared workspace. In the example of FIG. 10, the user has used the moved an application/object 1010 from objects 530 to a shared workspace 1020. To interact with user workspace 500 the user utilizes, for example, the user computer 150(1)'s display 152(1) and input device 154(1) to access cloud 160. In this example of moving object 1010 from objects 530 to a shared workspace 1020 is accessing cloud 160 such that object 1010 is copied from a storage location, for example the user's cloud storage space, to a workspace. Applications/objects, one example of which is application/object 1010, may be licensed from system 100,150. An application that has been created in an organization cloud is dragged and dropped by an administrator (not shown) of an application creation organization (not shown) from the organization cloud to the deployment cloud. Once the application is in the deployment cloud the users can use a keyword search to find it. The administrator may be one of the users of user workspace 500 that has special access capabilities and privileges.

Once an application/object has been moved to the shared workspace 500, it can be invoked by users having access thereto.

The number on the left side of the application icon, the number “6” in the example shown in FIG. 10, represents an example of the number of uses available to the user for the application. This number is also called the “use count” herein. In the present embodiment, a use is a use within a 24-hour period starting when the application is first activated. The application may be used an unlimited number of times during that 24-hour period. Other time periods may be used without departing from the scope herein. Alternatively, the use count displays the number of times an application can be executed. The use count is decremented upon the first invocation of an application for a 24-hour period. Dragging and dropping an application onto the shared workspace for execution means that the shared workspace is a platform and so represents Platform as a Service (PaaS).

If an application comes with an input dataset then its display screens will not be shown. Instead, the inputs will come from that dataset.

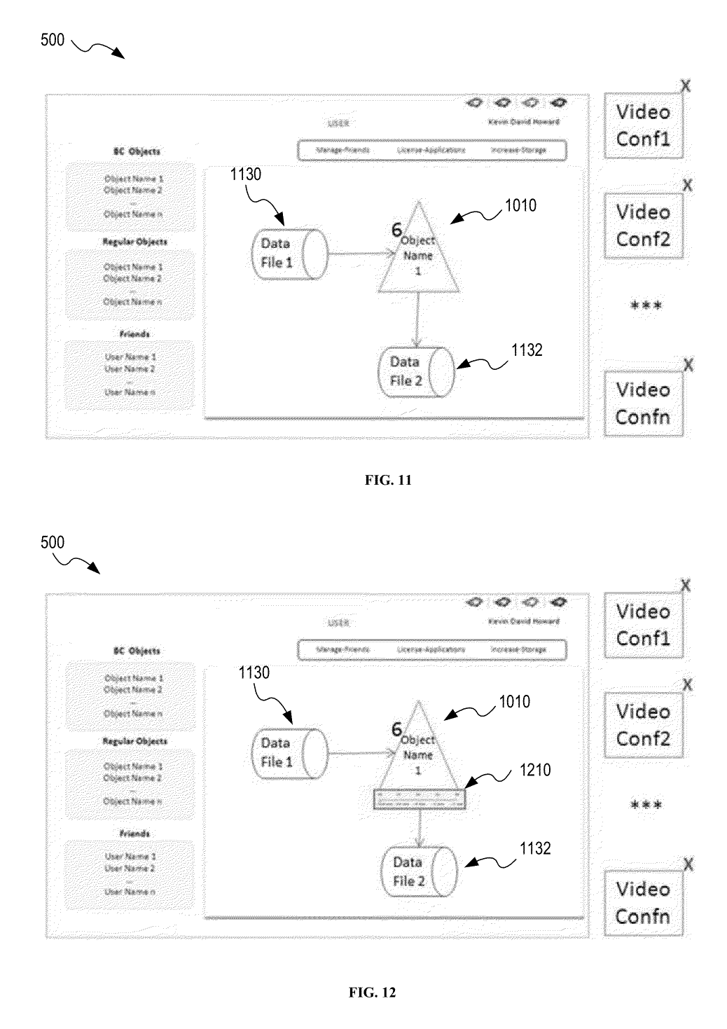

FIG. 11 shows workspace 500 with data files 1130 and 1132. If an application has an input dataset and has been parallelized, then a speedup chart for the dataset is associated with a “Speedup Chart” 1210 (FIG. 12), attached to application icon 1010. In the present example, data file 1130 is an input data file and data file 1132 is an output data file.

FIG. 12 shows application/object 1010 with the associated “Speedup Chart” 1210. In an embodiment, by double-clicking the application icon 1010 the user invokes the application.

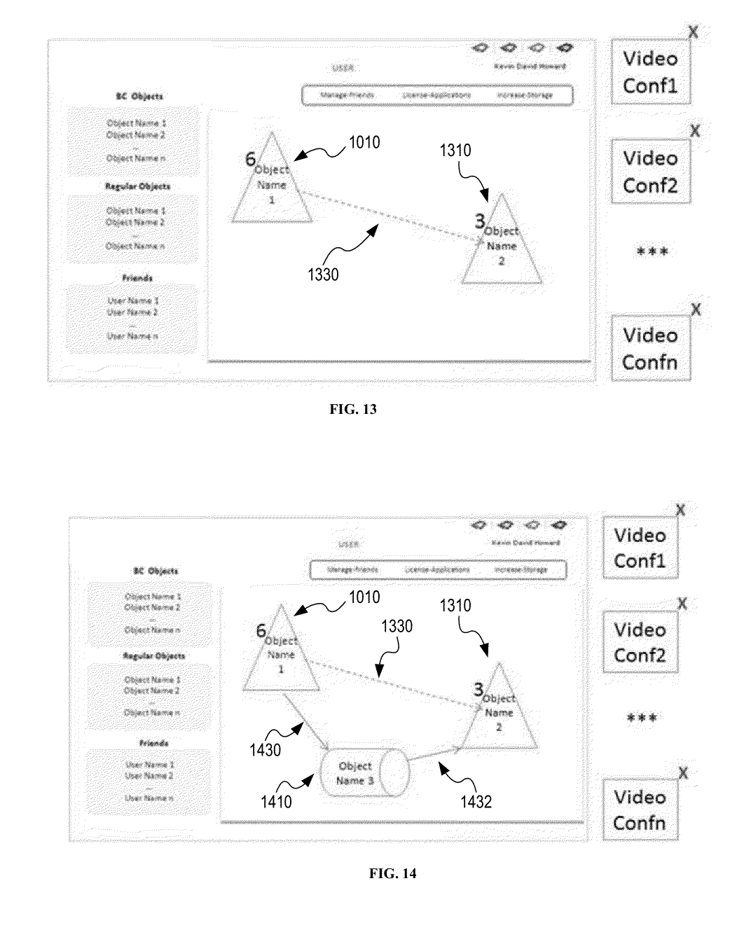

Two or more applications, similar to application 1010, can be chained together by dragging and dropping multiple applications then, for example, left-clicking one application followed by next application to link the two applications together. FIG. 13 shows two applications 1010, 1310 linked together by an application linkage 1330. In an embodiment, to start a workflow, the user starts an application by double-clicking on the application. The first invoked application 1010 displays the input and output screens of the application. One example of the input screen is screen 800. Screen 800 may also include an output screen such that an input/output version of screen 800 would display the output, for example, below the input. A second application 1310, which linked 1330 to the first application 1010, is automatically invoked after application 1010 has finished its operation. The workflow stops when there are no applications left to invoke.

The output of an application may be used as the input into another application. One method of supplying an output from one application to another is shown in FIG. 14, where application 1010 is linked 1430 to data store 1410 and data store 1410 is linked 1432 to application 1310. Data store 1410 represents a data file, for example, stored in the user's cloud storage space, where application 1010 stores its output data. In the instance where there is no input file for an application in shared workspace 1020, the application's initial display screen/input screen, similar to input screen 800, may be displayed such that the user may enter data.

Data storage allocation occurs through server 101 (FIG. 1) and may be represented using an icon on the shared workspace. Adding, deleting, and associating data storage on the cloud represents IaaS.

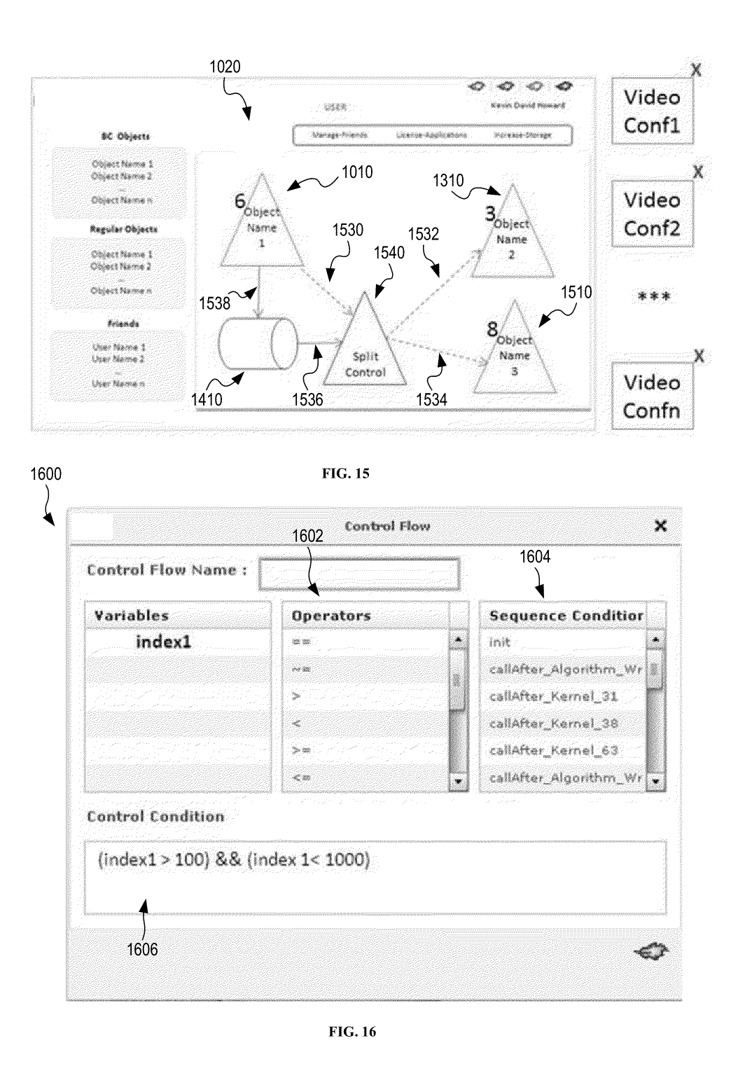

FIG. 15 shows shared workspace 1020 including three object/applications 1010, 1310, 1510, one control application 1540, and one data store 1410. Control application 1540 is linked 1530, 1532, 1534, 1536 to all other objects. In addition, application 1010 is linked 1430 to data store 1410. Control application 1540 may perform simple decision and control functionality. A control application, like control application 1540, must be connected to both a data store and an application to function properly. In an embodiment, the control application acts as an “IF” statement. As such, the control statement needs to know which variable to use in the decision. In one example, a variable “A1” in datastore1 may be checked to determine if its value is greater than 10. If “A1” is equal to 11 then the system will choose the “True” path, else the “False” path is chosen. Choosing a path means to run the next object on that path.

In an embodiment, double-clicking on a link, for example, link 1532 or link 1534, causes to be displayed the control condition for determining which link 1532, 1534 to follow.

FIG. 16 shows a control conditions screen 1600 for selecting control conditions for one or more links, for example, links 1532, 1534 of FIG. 15. Control conditions screen 1600 provides one possible way of associating one or more user selectable control conditions with a link. Control conditions allow a user to input mathematical/logical conditions using either constants or the available parameters. FIG. 16 shows selectable control conditions using user selectable operators 1602 and sequence conditions 1604. Exemplary control condition 1606 for “index1” is also shown in FIG. 16.

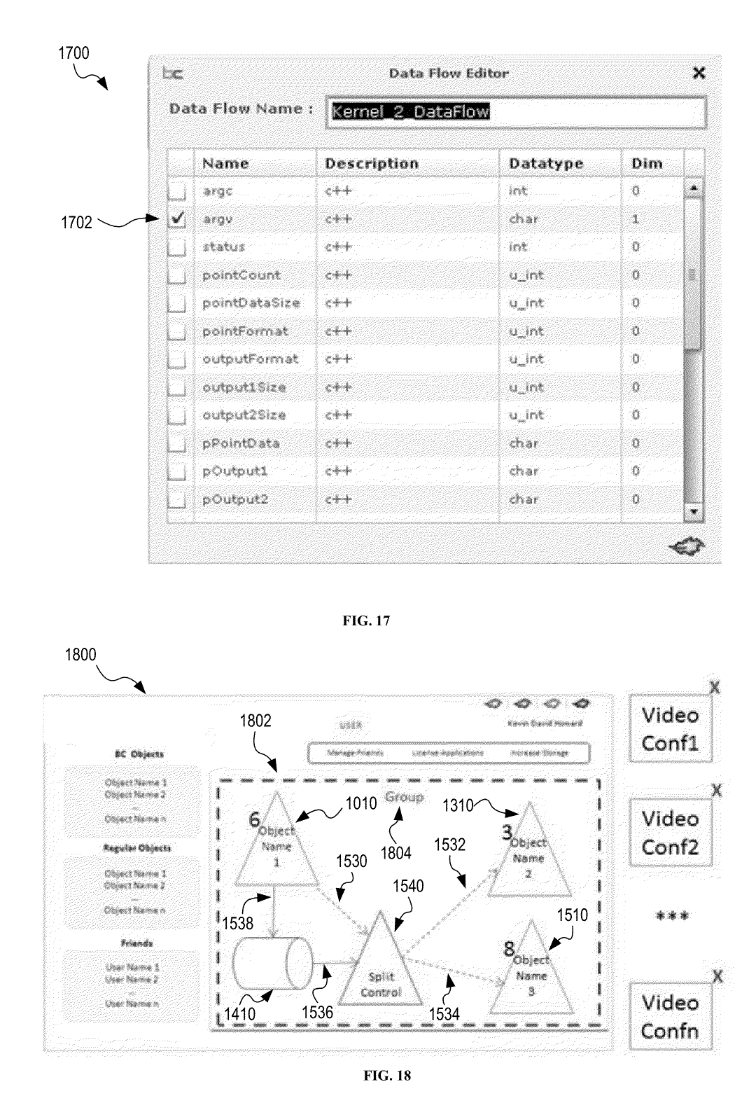

FIG. 17 shows an exemplary data flow editor 1700. By double-clicking on a link from an application to a data store, for example link 1538 (FIG. 15), a variable selection screen 1700 is displayed and shows all variables and structures that may be produced by an application and stored in a data store. In the example of FIG. 17, variable selection screen 1700 shows all the variables produced by application 1010 that may be stored in data store 1410. In operation, the user selects one or more variables to be saved in the data store. In the example of FIG. 17, the user selected, by clicking check box 1702, the “argv” C++char variable having one dimension. As discussed about, data saved to a data store may be utilized as an input to another (or the same) application. Alternatively, data saved to a data store may be output for display to a user or organized in a manner that may be displayed or utilized by an application that is not associated with system 100, 150.

By double-clicking on a link from a data store to an application/object will show all possible variables or structures that are stored within the data store and processable by the application/object, one example of which is link 1432. This variable display screen is similar to variable selection screen 1700, although more, fewer, or different named variables may be displayed. By selecting a named variable or structure, the user selects an input to the next application, in the example of link 1432 the selected named variable or structure would be the input to application/object 1310.

FIG. 18 shows objects grouped together. Grouping may be used to perform a plurality of functions. For example, it is also possible to save a workflow by grouping two or more applications/objects, then saving the group. In the embodiment of FIG. 18, the user has selected a group by right clicking on a blank part of the shared space and dragging the mouse cursot to another part of the screen such that a selection box 1802 is drawn around the applications/objects 1010,1310, 1410, 1510, 1540 to be grouped, then releasing the right mouse button. This causes both the selection box 1802 and a “Group” button 1804 to appear. Selecting “Group” button 1804 causes all applications/objects within selection box 1802 to be grouped together as a single object. In the present example, this action may be used to save the selected workflow, for example to the user's cloud storage space. In a separate embodiment, grouping may be used to create a new object that may be used as an application/object in a workspace.

In an embodiment, the grouped workflow may be dragged and dropped into the objects space 530, causing system 100, 150 to request an object name for the grouped workflow, thereby saving the grouped workflow as a named object. The named object can now be dragged and dropped back onto the shared space whenever required.

Collaboration (CaaS)

Selection of the “Manage Friends” button 512 causes the “Manage Friends” screen 1900 to be displayed.

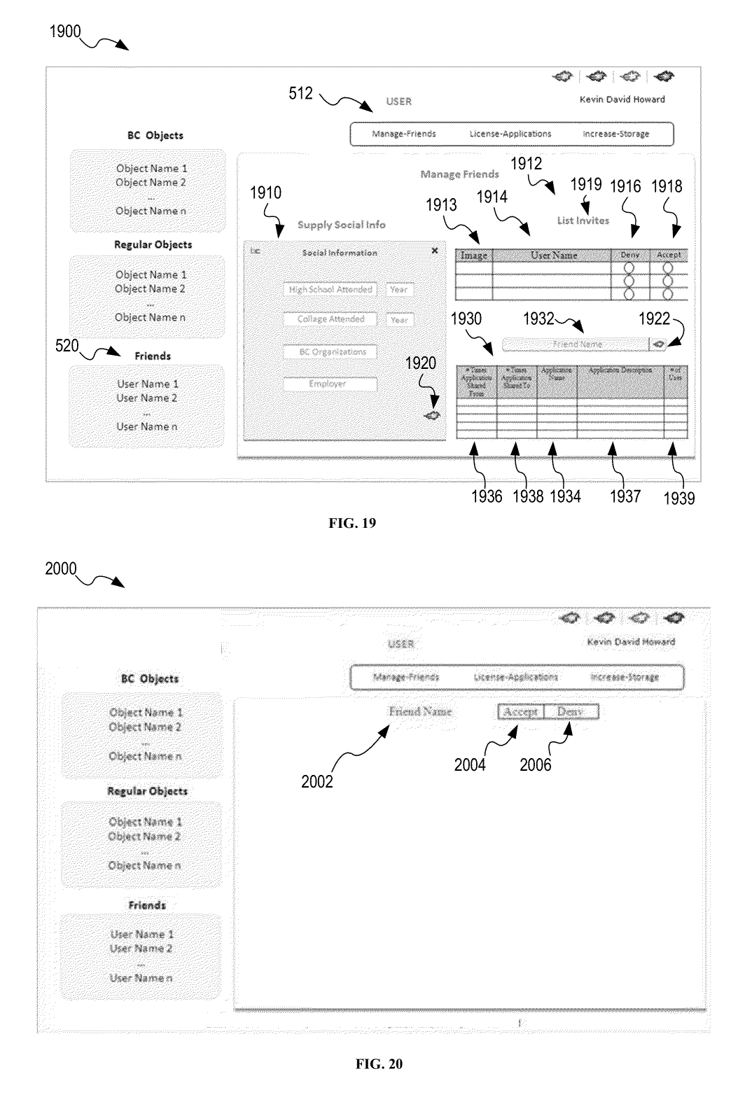

FIG. 19 shows the “Manage Friends” screen 1900. This screen provides functionality such that a user may, for example, search for friends registered with system 100, 150 by entering search criteria in a social information menu 1910. That is, social information menu 1910 may be used as search criteria for locating other registered users, or “friends.” After one or more fields within social information 1910 are filled and a confirmation button 1920 is selected, system 100, 150 searches for users fitting data with social information menu 1910 and, when one or more matches are found, a list of potential code-sharing friends is displayed, along with a button used to invite them as friends.

One example of an empty invite list is shown as table 2, below, and may be displayed as a pop-up menu. An “Image” column may display a photo of the friend, an image of an avatar representing the friend, or some image selected to represent the friend. A User Name column displays names that may be the friend actual name or a screen name selected by the friend. The Invite column includes one or more selectable buttons for selecting one or more friends to include in Friends sub-menu 520.

TABLE 2
Invite List

| | | |
|---|---|---|
| Image | User Name | Invite |

◯
◯
◯

FIG. 19 also shows a List Invites button 1919 and a List Invites menu 1912. By selecting List Invites button 1912 a list of all users who are trying to befriend the user is displayed. To accept an invitation, an “Accept” 1916 field of a requesting user may be selected. To remove an invitation, a “Deny” 1918 field of a requesting user may be selected. List Invites menu also includes, an image column 1913, and a user name column 1914, each for identifying users that are attempting to befriend the user.

FIG. 19 also shows a Friend Data screen 1930 that provides functionality for reviewing data associated with the user's friends. In one example, the user may determine the names and some details associated with applications licensed by a friend, for example a friend listed in Friends sub-menu 520 or list invites 1912. In one example of operation, the user enters the friend's name into the “Friend Name” search field 1932 and selects of the confirmation button 1922. A list of system 100, 150 applications licensed by the selected friend will be displayed in a “Friend's Applications” screen 1930. “Friend's Applications” screen 1930 also may display the number of times the user has accessed that friend's application license(s) 1936, how many times the friend has used the current user's application license(s) 1938, the application name 1934, the application description 1937, and the number of uses left on the friend's license 1939.

FIG. 20 shows a Friend Video engagement screen 2000. Once a friendship has been established, a video or instant-messaging (IM) communication between selected friends can occur, for example, utilizing Video Conference capability 550. A list of all friends can be found under the “Friends” sub-menu 520 on the main screen. In an embodiment, the user may engage one or more of the Friends sub-menu 520 displayed friends, for example, by double-clicking the row containing the friend's name. In one embodiment, the displayed name will change colors from black to red, indicating that an engagement request has been sent. The user's name 2002 will be displayed flashing at the top of the friend's screen to communicate that the user is attempting to initiate a video conference. The friend may either accept 2004 or deny 2008 the engagement request.

FIG. 21 shows a video chat screen 2100. If the friend who received the engagement request as discussed in FIG. 20, above, accepts 2004 the engagement request, system 100, 150 displays video chat screen 2100, if video is enabled, or an IM session, if video is not available. In an embodiment, both the IM and the video chat are created using an ad hoc network.

Shared Workflows and Collaboration

It is possible to combine and share application licenses within a workflow through the shared workspace. To form a shared workspace, the user selects a friend and sends an engagement request, the friend accepts the engagement request, at which point the user drags and drops the workflow into the shared space. In an embodiment, the imagery of the shared workspace is shared using the botnet system. The user can ask the friend to use some of the “uses” from his/her license. If the friend accepts, the friend right-clicks on the objects in question and enters the number of uses he is sharing with the user. This number is subtracted from the friend's available uses.

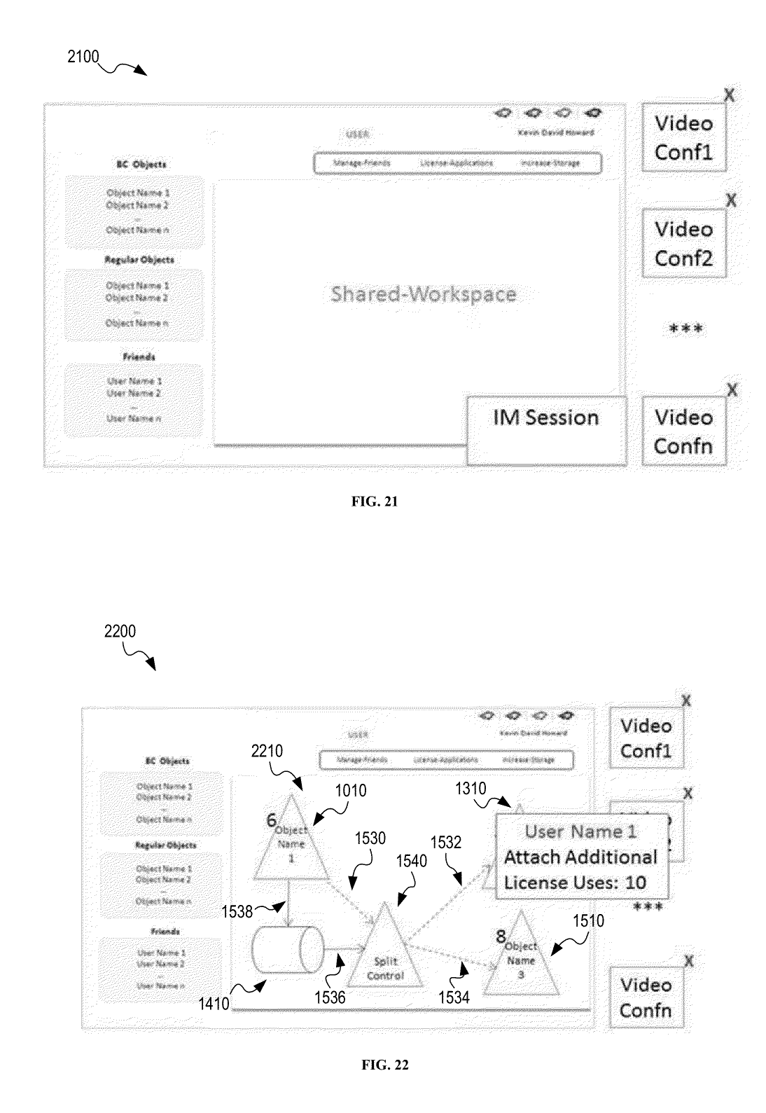

FIG. 22 shows one example of a shared workspace 2200, in an embodiment. Any output datasets generated by a shared workflow 2210 in the shared workspace 2200 can be copied from shared space 2200 to the user's computer or any computer of a friend who is sharing the shared workspace 2200. In addition, workflow 2210 can be copied to the computer of any friend who is engaged with workflow 2210 in shared workspace 2200. Workflow 2210 can be activated by any friend who copied it if there are existing license uses left on all applications/objects within the workflow. If there are two or more unengaged friends active on the workflow on the same day, only a single use for the associated applications/objects is consumed for that day. FIG. 22 shows the same workflow as discussed in FIG. 15, above.

Other Simple Workflows

It is possible to construct a workflow from applications/objects that are not generated within system 100, 150, called a “Regular” object herein, by dragging and dropping the “Regular” object into the shared space. Like in-system application/objects, “Regular” objects are attached via data stores, similar to data stores 192 (FIG. 1B). In an embodiment, “Regular” objects are executed on the computer of the originating user. When the user activates a workflow containing a “Regular” object, that object is executed on that user's machine as long as the user has an existing license on his/her machine to execute the object.

Other Shared Workflows

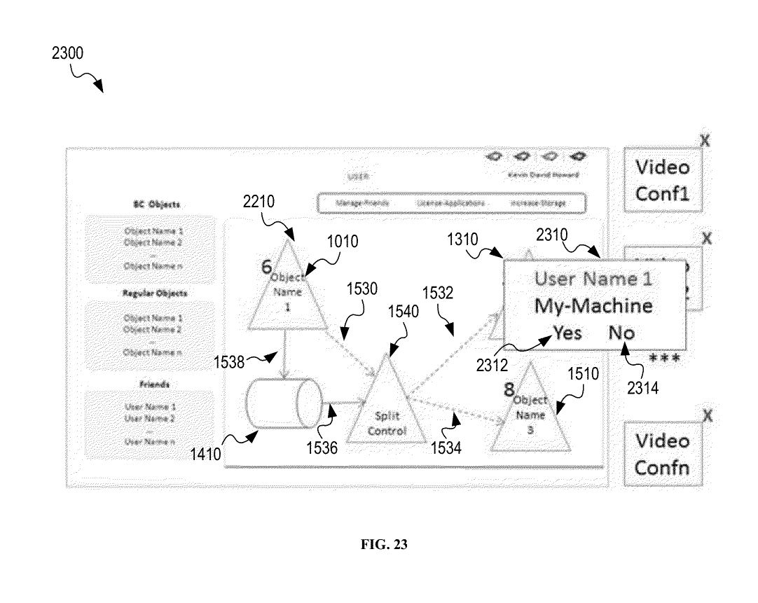

Friends can share a workflow containing “Regular” objects as long as those objects are assigned to work on one or more user machines and the executing machine contains an existing “Regular” object license. Sharing “Regular” objects never violates existing license agreements because the code is running on the licensed machine, with only control (through the bots) being distributed. If there is no engaged friend with a machine containing a valid license, the “Regular” object cannot be executed. A friend can select his machine as the executing machine for a “Regular” object by right-clicking on the “Regular” object in question and selecting the “My Machine—Yes” button. In the example of FIG. 23, object 1310 is a “Regular” object on the user's machine, but not a friend's machine. The friend may right-click on “Regular” object 1310 and may select, in a My Machine 2310 popup menu, a Yes button 2312. A No button 2314 may also be selected, although this will cause object 1310 to not be executed.

Combined Workflows

It is possible to co-mingle in-system and “Regular” objects in the same workflow.

Data

Data can be saved on system 100, 150 servers simply by dragging and dropping a data store icon to the object area 530 of the screen. Dragging and dropping a data object to the “Regular Objects” 540 portion of the screen causes the data to be moved to the user's own disk storage.

Data Retention Time

AdSaaS allows the user to specify the retention time of any data saved on system 100, 150 servers. In an embodiment, this retention time can range from one minute to forever. Allowing data to have a defined lifespan in the user's cloud storage space decreases the risk of data theft and automatically removes unwanted data without human intervention, thereby automating the user's data management.

Data Storage Amount

AdSaaS allows the user to specify the amount of storage available in total and per application by selecting the “Increase Storage” button then entering the values on the “Storage” display.

TABLE 3
Data Storage

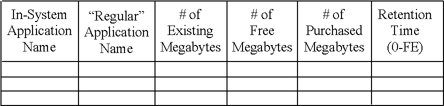

(Note: 0-retention = for current run, FE = forever, else Values in Seconds

Additional storage can be purchased by double-clicking the row in question, causing the “Storage Purchase” screen to appear.

TABLE 4
Data Storage purchase

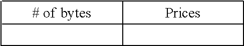

Changes may be made in the above methods and systems without departing from the scope hereof. It should thus be noted that the matter contained in the above description or shown in the accompanying drawings should be interpreted as illustrative and not in a limiting sense. The following claims are intended to cover generic and specific features described herein, as well as all statements of the scope of the present method and system, which, as a matter of language, might be said to fall there between.

What is claimed is:

1. A system for allowing a user to run an application, comprising:
a server including a processor coupled with memory storing instructions executable by the processor, the instructions capable of:
providing, within a development cloud hosted by the server and accessible by a user, advanced software as a service (AdSaaS), wherein the AdSaaS (a) allows the user to select a version of an application stored within the memory, and (b) allows the user to execute a selected version of the application.

2. The system of claim 1, wherein the memory stores speedup configuration data accessible by the user;
the instructions further capable of receiving a selection, from the user, of a processing speed for the version of the selected version of the application, and identifying to the user a cost associated with the selected processing speed.

3. The system of claim 1, wherein the AdSaaS further facilitates user control of a parallel processing method for allocation, de-allocation, and manipulation of a Network as a Service (NaaS).

4. The system of claim 1, wherein the instructions are capable of generating a user workspace and receiving interaction from the user through a Platform as a Service (PaaS).

5. The system of claim 4, wherein the PaaS comprises a web-browser interface platform displayed on a user computer.

6. The system of claim 1, the instructions further capable of providing an Infrastructure as a Service (IaaS); and wherein the memory includes allocated storage space for the user; the AdSaaS capable of receiving a request, from the user, to acquire additional storage space for use with the IaaS.

7. The system of claim 1, the instructions further capable of providing, within the development cloud, a Collaboration as a Service (CaaS);
the development cloud being accessible by the user and at least one additional user;
the memory storing an application database identifying each user with application licenses owned thereby;
the instructions further capable of receiving a request by the user to access a licensed application licensed by one of the at least one additional users, and in response to the request allowing the user to access the license of the at least one additional user thereby allowing the user to run the requested application.

8. The system of claim 1, the instructions further capable of:
hosting a user workspace within the development cloud and accessible by the user;
receiving interaction from the user to create, within the user workspace, a complex workflow using combine botnet and at least two different applications.

9. The system of claim 8, the instructions further capable of: receiving a request from the user to save the user workspace for a given amount of retention time.

10. The system of claim 8, the complex workflow comprising an in-system object, that is executable on a computer of the user, and a regular object that is executable on a device remote from the computer of the user.

11. The system of claim 1, the instructions further capable of: receiving, from the user, a share request to share an application with another user who has access to the development cloud.

12. The system of claim 11, the instructions further capable of: providing a video conference, integrated with the developer cloud, between the user and an additional user.

13. The system of claim 1, the memory storing an application database identifying applications, licenses associated with the application, and users associated with the licenses, wherein the instructions are further capable of: tracking a the number of uses for a given license for a given user.

14. The system of claim 1, the instructions further capable of: running an application licensed by the user with a given data set, running a second application with the given dataset, and generating a comparison of the results from the first and second applications.
